(19) United States
(12) Patent Application Publication
(10) Pub. No.: US 2008/0252058 A1
(43) Pub. Date: Oct. 16, 2008

(54) Seatbelt system

(75) Inventor: Mark F. Gray, Sterling Heights, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 12/078,933

(22) Filed: Apr. 8, 2008

Related U.S. Application Data
(60) Provisional application No. 60/907,705, filed on Apr. 13, 2007.

(51) Int. Cl. B60R 22/48

(52) U.S. Cl. 280/801.1

(57) ABSTRACT

A seat with a four point seat belt system includes first and second seatbelts, and first and second interlock mechanisms. The first seatbelt includes a shoulder portion and a lap portion. The second seatbelt includes a shoulder portion. A first interlock mechanism prevents latching of the second seatbelt into a buckle before latching of the first seatbelt into a buckle. A second interlock mechanism unlatches one of the first and second seatbelts from a buckle upon unlatching of the other of the first and second seatbelts from a buckle.

### CROSS-REFERENCE TO RELATED PATENT APPLICATIONS

This application claims priority to U.S. Provisional Application No. 60/907,705, filed Apr. 13, 2007, which is incorporated herein by reference in its entirety.

### BACKGROUND

The present invention relates generally to the field of seatbelt systems. More specifically, the invention relates to a four-point seatbelt system.

Conventional four-point seatbelt systems can cause undesirable effects for the occupant due to the action of the shoulder harness drawing the lap belt up over the occupant's hips and into the abdomen during loading of the seatbelt system.

In conventional four-point seatbelt systems, an occupant generally must use two hands to buckle the seatbelt together. The conventional four-point systems are generally designed such that one hand must hold a buckle and a second hand must hold a latch for the seatbelt; thus requiring a two-handed action.

### SUMMARY

One exemplary embodiment provides a seat with a four point seat belt seatbelt. The seat comprises: a first seatbelt including a shoulder portion and a lap portion, wherein one end of the first seatbelt being coupled to a first retractor, an opposite end of the first seatbelt including a first latch to couple to a first buckle, and a middle portion slidably coupled to an anchor; a second seatbelt with a shoulder portion, one end of the second seatbelt being coupled to a second retractor and an opposite end of the second seatbelt including a second latch to couple to a second buckle; and a first interlock mechanism configured to prevent latching of the second seatbelt into the second buckle before latching of the first seatbelt into the first buckle.

Another exemplary embodiment provides a four-point seatbelt system. The seatbelt system comprises a three-point seatbelt, a two-point seatbelt, and an interlock mechanism. The interlock mechanism prevents buckling of only the two-point seatbelt by preventing latching of the two-point seatbelt prior to latching of the three-point seatbelt.

Yet another exemplary embodiment provides a four-point seatbelt system. The seatbelt system comprises a three-point seatbelt, a two-point seatbelt, and an interlock mechanism configured to unlatch one of the first and second seatbelts upon unlatching of the other of the first and second seatbelts.

It is to be understood that both the foregoing general description and the following detailed description are exemplary and explanatory only, and are not restrictive of the invention as claimed.

### BRIEF DESCRIPTION OF THE DRAWINGS

Features, aspects, and advantages of embodiments of the present invention will become apparent from the following description, and the accompanying exemplary embodiments shown in the drawing, which is briefly described below.

FIG. 1 is a view of a vehicle seat with a four-point seatbelt system according to an embodiment.

FIGS. 2(a)-2(c) are schematic views of the interlock mechanisms. FIG. 2(a) is a detail view of a first buckle, FIG. 2(b) is a detail view of a retractor, and FIG. 2(c) is a detail view of a second buckle.

### DETAILED DESCRIPTION

Conventional four-point seatbelt systems used in aftermarket and sport utility vehicles (SUV's) require a two-handed approach to place the seatbelts around an occupant.

According to an embodiment, a four-point seatbelt system comprises a three-point seatbelt and a two-point seatbelt. The combination of the three-point seatbelt and the two-point seatbelt form a four-point protection for a vehicle occupant. For example, the three-point seatbelt system for a driver-side seat contains three points: left-side shoulder, right-side hip, and left-side hip. For example, the two-point seatbelt system for a driver-side seat contains two points: right-side shoulder and left-side hip.

The three-point seatbelt includes a first shoulder portion extending diagonally across an occupant's chest, and a first lap portion extending across an occupant's lap. Webbing of the first shoulder portion (and, thus, the three-point seatbelt) pays out from a spool of a first retractor at or near the occupant's left or right shoulder and connects to a first buckle at a left or right hip side of the occupant/seat. The first lap portion is a segment of webbing that extends from the first buckle to an opposite side of the occupant's seat/hip and connects to an anchor.

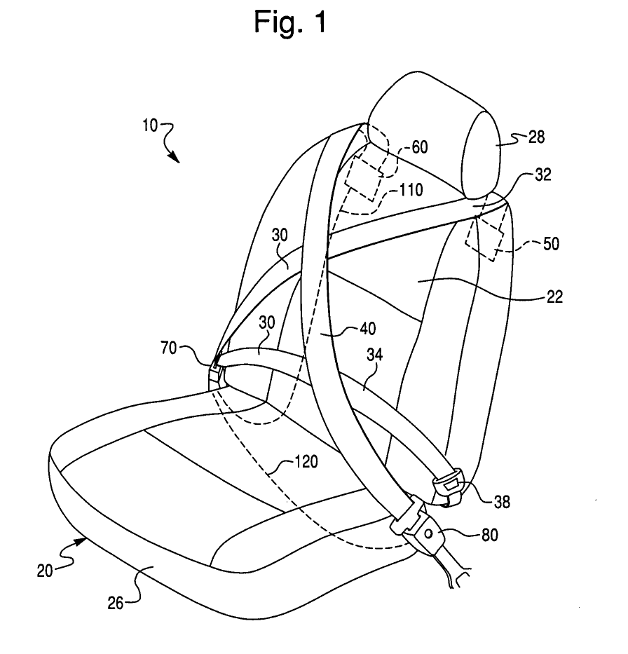

The supplemental two-point seatbelt extends diagonally across an occupant's chest and crosses over the shoulder belt portion of the three-point seatbelt. The two-point seatbelt preferably pays out from the shoulder area of the occupant (for example, the right shoulder in FIG. 1), but could pay out from the lap (hip) area of the occupant.

According to an embodiment, an occupant protection device comprises a three-point seatbelt, a two-point seatbelt, and a first interlock mechanism. The interlock mechanism prevents the latching of the two-point seatbelt to a buckle prior to latching the three-point seatbelt to a buckle.

According to an embodiment the first lock mechanism prevents a retractor from paying out webbing of the two-point seatbelt when the three-point seatbelt is not buckled.

According to another embodiment, the occupant protection device comprises a second interlock mechanism that is configured to release both buckles upon pressing of a single release button on one of the buckles.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components or the two components and any additional member being attached to one another. Such joining may be permanent in nature or alternatively may be removable or releasable in nature.

Embodiments will now be described with reference to the drawing.

FIG. 1 illustrates an embodiment of the four-point seatbelt. In FIG. 1, a vehicle seat 20 includes a seat back 22, a seat bottom 26, and a headrest 28. A four-point seatbelt system 10 is utilized with the seat 20. The four-point seatbelt system 10 includes a three-point (first) seatbelt 30 and a two-point (second) seatbelt 40.

The three-point seatbelt 30 includes a shoulder portion 32 and a lap portion 34. The three-point seatbelt 30 latches to a first buckle 70. An end of the shoulder portion 32 is coupled (directly or indirectly) to a first retractor 50. The three-point seatbelt 30 may also be coupled (directly or indirectly) to an anchor 38 at an end of the lap portion 34.

The two-point seatbelt 40 includes, in an embodiment, a shoulder portion that connects to a second buckle 80 at one end. An opposite end of the two-point seatbelt 80 is coupled (directly or indirectly) to a second retractor 60.

According to an embodiment, such as shown in FIG. 1, the four-point seatbelt system 10 may include a first interlock mechanism 110. The first interlock mechanism 110 extends between the second retractor 60 (for the two-point seatbelt 40) and the first buckle 70 (of the three-point seatbelt 30). The first interlock mechanism 110 can comprise a first cable 112 to prevent the use (i.e., latching) of the two-point seatbelt 40 unless the three-point seatbelt 30 is already buckled and in use by an occupant. According to one embodiment, the second retractor 60 will not be able to pay out any webbing for the two-point seatbelt 40 unless the three-point seatbelt 30 is latched to the first buckle 70. Alternatively, the second buckle 80 will not be able to move into a latched position with a latch 46 of the second two-point seatbelt 40 unless the three-point seatbelt latch 36 is latched to the first buckle 70. The first interlock mechanism 110 will be explained in greater detail below.

In yet another embodiment, the first interlock mechanism can include an electrically driven mechanism, which may include sensors, to prevent the second retractor 60 from paying out webbing for the two-point seatbelt 40 prior to latching of the three-point seatbelt 30 and/or prevent latching of the two-point seatbelt 40 to the second buckle 80 prior to latching of the three-point seatbelt 30 to the first buckle.

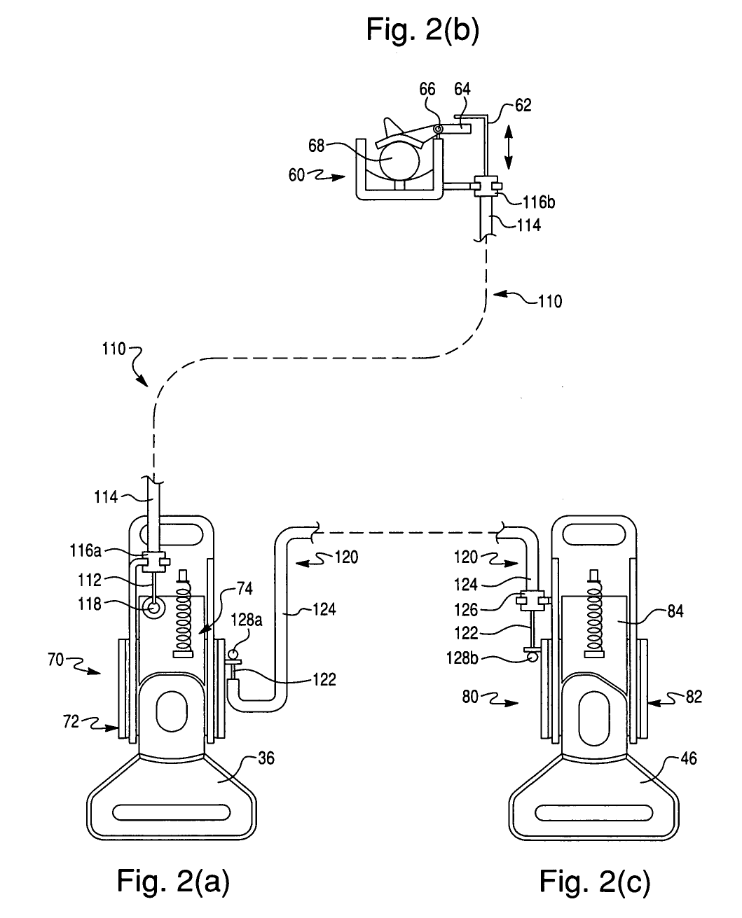

In an embodiment, releasing the four-point seatbelt system 10 may be achieved by pressing a release button 72 (FIG. 2(a) on the buckle 70 for the three-point seatbelt 30, which would also release the buckle 80 for the two-point seatbelt 40 through a second interlock mechanism 120. The second interlock mechanism 120 may include a second cable 122, an electronic control, or any other suitable mechanism. The second interlock mechanism 120 will be explained in greater detail below.

In yet another embodiment, the two-point seatbelt 40 may be released prior to, with, or after releasing the three-point seatbelt 30 by pressing a release button 72 on the buckle 70. Alternatively, the three-point seatbelt 30 may be released from the first buckle 70 prior to, with, or after releasing the two-point seatbelt 40 by pressing a release button 82 on the second buckle 80.

The first interlock mechanism 110 will now be explained with reference to FIGS. 2(a) and 2(b). The first interlock mechanism 110 is configured to prevent the second (two-point) seatbelt 40 from latching with the second buckle 80 prior to latching of the first (three-point) seatbelt 30 with the first buckle 70. The first interlock mechanism 110 includes a cable 112 (or other suitable device) that couples the second retractor 60 to the first buckle 70.

The cable 112 is surrounded at least partly by a housing 114. Each end of the housing 114 includes a housing attachment 116a, 116b. For example, the end of the housing 114 proximate the second retractor 60 ends at housing attachment 116b. The end of the housing 114 proximate the first buckle 70 ends at housing attachment 116a. The housing attachments 116a, 116b can include a grooved lug that fits into a forked portion of the second retractor 60 or first buckle 70 (such as shown in FIGS. 2(a) and 2(b)).

The cable 112 at the first buckle 70 extends out of the housing attachment 116a and ends at a cable terminal or ball unit 118. The cable terminal 118 is coupled to the ejector plate 74 of the buckle 70. The opposite end of the cable 112 ends at the cable housing attachment 116b. The housing attachment 116b is coupled to a push lever 162. When the first latch plate 36 of the three-point (first) seatbelt 30 is latched into the first buckle 70, the latch plate 36 pushes the ejector plate 74 towards the end of the buckle 70 and, thus, the cable terminal 118 moves towards the housing attachment 116a. This movement of the ejector plate 74 and cable terminal 118 moves the cable and cable housing attachment 116b at the second retractor 60. As the ejector plate 74 is moved into a latched position, the housing attachment 116b end of the cable 112 moves the push lever 112 such that the push lever 112 releases the contact lever 64 to allow the spool 68 to rotate and pay out webbing for the two-point (second) seatbelt 40. When the first latch plate 36 is not latched into the buckle 70, the ejector plate 74 and cable terminal 18 are in a downward position (in FIG. 2(a)) and, therefore, the push lever 62 pushes down on the contact lever 64. The contact lever 64 is pivoted at a pivot point 66 which locks the spool 68 and prevents withdrawing of webbing for the two-point (second) seatbelt 40.

In an alternate embodiment, the first interlock mechanism 110 couples the first buckle 70 with a second buckle 80 via the cable 112. The first interlock mechanism 110 would operate similarly to that described above, except that the second cable housing attachment 116b would be attached to the release button 82 or ejector plate 84 of the second buckle 80. In this embodiment, the interlock mechanism 110 would prevent latching of the second latch 46 to the second buckle 80 prior to latching the first latch 36 to the first buckle 70. The interlock mechanism 110 would, if the first buckle 70 is not buckled, hold the second release button 82 in a depressed (i.e., a release mode) position to prevent latching or hold the ejector plate 84 in position and prevent the ejector plate 84 from moving to accept and latch the second latch 46 with the buckle 80.

The second interlock mechanism 120 will now be explained with reference to FIGS. 2(b) and 2(c). The second interlock mechanism 120 is configured to unlatch one of the first 30 and second 40 seatbelts upon unlatching of the other of the first 30 and second 40 seatbelts. Thus, the second interlock mechanism 120 can allow for one-handed (and one-button) release of the four-point seatbelt system 110.

The second interlock mechanism 120 includes a cable 122 (or other suitable device) that couples the first buckle 70 to the second buckle 80. The cable 122 is surrounded at least partly by a housing 124. The end of the housing 124 at the second buckle 80 includes a housing attachment 126. The housing attachments 126 is similar to attachments 116a, 116b and can include a grooved lug that fits into a forked portion of the second buckle 80 (such as shown in FIG. 2(c)). The housing attachment 126 is connected to part of the housing for the buckle 80.

The cable 122 at the first buckle 70 extends out of the housing 124 and ends at a cable terminal or ball unit 128a. The cable terminal 128a is connected to the first release button 72. The other end of the cable 122 at the second buckle 80 extends out of the housing 124 and ends at a cable terminal or ball unit 128b. The cable terminal 128b is connected to the release button 82 of the second buckle 80.

The second interlock mechanism 120 operates such that when a latch plate 36 of the three-point (first) seatbelt 30 is latched into the buckle 70, the first release button 72 also moves into the latched position. When in the latched position, the first release button 72 positions the connected cable terminal 128a such that the cable 122 moves and allows the cable terminal 128b to move into a latchable position. In this position, the cable terminal 128b, which is connected to the second release button 82, permits a second latch plate 46 from a two-point (second) seatbelt 40 to latch with the second buckle 80. When the first latch plate 36 is unlatched from the first buckle 70, the release button moves 72 into the unlatched position and moves the cable terminal 128a and cable 122 accordingly. When the cable terminal 128a at the first buckle 70 moves into the unlatched position, the cable 122 and cable terminal 128b at the second buckle 80 holds the second release button 82 in the release position to prevent latching of the second latch plate 46 into the buckle 80.

In an embodiment, the seatbelt system 10 may include one or more sensors with the first and/or second interlock mechanisms 110, 120.

In an embodiment, the first 36 and second 46 latch plates and first 70 and second 80 buckles are configured such that the second latch plate 46 cannot be inserted into the first buckle, and the first latch plate 36 cannot be inserted into the second buckle 80. The latches 36, 46 are configured such that they will not fit into the wrong buckle, which may be accomplished by each latch plate 36, 46 having a different shape corresponding with the appropriate buckle 70, 80. Alternatively, this may be accomplished by utilized different sized (thicker, larger, etc.) latches 36, 46 and/or ejector plates 72, 82, utilizing dimples, or other mechanisms or features.

It is an object of embodiments to prevent an occupant from buckling only the two-point seatbelt 40 prior to buckling (using) the three-point seatbelt 30. Thus, it is an object of embodiments to prevent latching/buckling of the two-point seatbelt 40 prior latching/buckling of the three-point seatbelt 30.

According to an object of embodiments, the three-point seatbelt 30 and the two-point seatbelt 40 forming the four-point seatbelt system 10 can be buckled and/or unbuckled with one hand.

It is important to note that the construction and arrangement of the four point belt system with interlock as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosure herein. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. Other substitutions, modifications, changes and omissions may be made in the design, operating conditions and arrangement of the exemplary embodiments.

What is claimed is:

1. A seat with a four point seat belt seatbelt, comprising:
a first seatbelt including a shoulder portion and a lap portion, wherein one end of the first seatbelt being coupled to a first retractor, an opposite end of the first seatbelt including a first latch to couple to a first buckle, and a middle portion slidably coupled to an anchor;
a second seatbelt with a shoulder portion, one end of the second seatbelt being coupled to a second retractor and an opposite end of the second seatbelt including a second latch to couple to a second buckle; and
a first interlock mechanism configured to prevent latching of the second seatbelt into the second buckle before latching of the first seatbelt into the first buckle.

2. The seat of claim 1, further comprising a second interlock mechanism configured to release one of the first and second buckles upon depressing a release button on the other of the first and second buckles.

3. The seat of claim 1, wherein the first seatbelt is a three point seatbelt, and the second seatbelt is a two point seatbelt.

4. The seat of claim 1, wherein the first and second retractors are positioned on a seat back or seat headrest.

5. The seat of claim 1, wherein the first interlock mechanism prevents withdrawing of the second seatbelt from the second retractor before the first seatbelt is latched in the first buckle.

6. The seat of claim 1, wherein the first interlock mechanism prevents latching of the second seatbelt into the second buckle before the first seatbelt is latched in the first buckle.

7. The seat of claim 1, wherein the first interlock mechanism includes a cable coupling the second retractor to the first buckle.

8. The seat of claim 7, wherein the first interlock mechanism includes a push lever configured to push a contact lever on the second retractor, and a cable terminal connected to an ejector plate of the first buckle, such that movement of the cable terminal from latching of the first seatbelt into the first buckle moves the push lever at the second retractor.

9. The seat of claim 2, wherein the second interlock mechanism includes a cable coupling the first buckle to the second buckle.

10. The seat of claim 9, wherein one end of the second interlock mechanism cable is connected to a first release button on the first buckle and an opposite end of the cable is connected to a second release button on the second buckle, such that depressing the first release button to unlatch the first buckle from the first seatbelt unlatches the second buckle from the second seatbelt.

11. The seat of claim 1, wherein the first latch comprises a configuration to match with only the first buckle to prevent latching of the first latch into the second buckle.

12. The seat of claim 1, wherein the shoulder portion of the first seatbelt crosses over the second seatbelt in a criss-crossed configuration.

13. A four-point seatbelt system, comprising a three-point seatbelt, a two-point seatbelt, and an interlock mechanism, and
wherein the interlock mechanism prevents buckling of only the two-point seatbelt by preventing latching of the two-point seatbelt prior to latching of the three-point seatbelt.

14. A four-point seatbelt system, comprising a three-point seatbelt, a two-point seatbelt, and an interlock mechanism, and
wherein the interlock mechanism is configured to unlatch one of the first and second seatbelts upon unlatching of the other of the first and second seatbelts.
